(19) United States
(12) Patent Application Publication
(10) Pub. No.: US 2006/0112107 A1
(43) Pub. Date: May 25, 2006

(54) Method and apparatus for controlling data access

(75) Inventor: Anthony G. Jones, Warwick (GB)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY (US)

(21) Appl. No.: 11/230,814

(22) Filed: Sep. 20, 2005

(30) Foreign Application Priority Data
Nov. 25, 2004 (GB) 0425857.0

(51) Int. Cl. G06F 17/30

(52) U.S. Cl. 707/10

(57) ABSTRACT

A method and apparatus is disclosed controlling access to data or documents in a distributed database where each set of data is associated with a set of permissions which determine the distribution and/or access for the data.

### FIELD OF INVENTION

The present invention relates to a method and apparatus for controlling data access. More particularly, but not exclusively, the present invention relates to a method and apparatus for managing access permissions to documents in a distributed database, which enables more effective control over copies of a master document.

### BACKGROUND OF THE INVENTION

Distributed databases commonly contain large numbers of duplicated or replicated documents. In some cases a number of duplicates of a given document may exist, each in different databases. Keeping each copy of a document up to date with its corresponding master document incurs a large administrative overhead. As a result, documents can become out of date.

In such databases, users are typically authorized to access particular databases based on the requirements of the organization in which the user operates. Although a user is given access to a whole database, they may only require access to a small proportion of the data held in that database. The administration of both duplication and user access is often carried out on an organizational level. In other words, the administrators of an individual database carry out the updating and user access control for only the databases which are they are directly responsibility.

### OBJECTS AND SUMMARY OF THE INVENTION

Accordingly, one object of the present invention is to enhance a replication relationship between databases.

Another object of the present invention is to provide document level controls for user access.

Yet another object of the invention is to provide a database management system in which unnecessary administration and data duplication is reduced.

Still yet another object of the present invention is to provide a method or apparatus for controlling data access, which avoids some of the above described disadvantages or at least provides the public with a useful choice.

According to a first aspect of the invention there is provided a method for controlling data access, in a distributed database, comprising the steps of creating a master set of data, associating a list of permissions with the master set of data, the permissions defining a list of containers permitted to hold a copy of the master set of data, and creating the copy by copying the master set of data to each container in the list.

Preferably, the master set of data is held in a master container, at least one container in the list utilizes access controls to control access to the copy of the data, and the set of data is a document. Preferably, the list of permissions further defines a list of users permitted to access a copy of the master set of data, the associated list of permissions is copied with each set of data to each container in the list, and the copy of the list of permissions in each container includes data indicating the location of the master set of data.

According to a second aspect of the invention there is provided apparatus for controlling data access in a distributed database comprising, a data record holding a master set of data, a list of permissions associated with the master set of data, the permissions adapted for defining a list of containers permitted to hold a copy of the master set of data, and a data transfer module for copying the master set of data to each container in the list.

According to a third aspect of the invention there is provided a method of accessing data in a distributed database comprising the steps of identifying a user and providing the user access to a database in accordance with the access permissions of the database, receiving a user selection of a document in the database, retrieving a set of permissions associated with the selected document, and if the user is identified in the set of permissions for the selected document then providing the user access to the document.

According to a fourth aspect of the invention there is provided a method of controlling access to data over a plurality of databases, the method comprising the steps of creating a document control list for a master document, the list identifying at least one database permitted to hold copies of the master document, transmitting one or more copies of the master document to at least one of the databases identified in the document control list, and transmitting copies of the document control list to the databases identified in the document control list.

Preferably, the document control list identifies the location of the master document and identifies one or more users who are permitted to access one or more of the copies of the document in the database.

According to a fifth aspect of the invention there is provided a method for controlling data access to a document in a distributed database, the method comprising the steps of creating a master document in a master database, defining a list of permissions associated with the master document, the permissions defining a list of databases permitted to hold a copy of the master set of data, and copying the master document and its associated permissions to each database in the list of permissions.

According to a sixth aspect of the invention there is provided a computer program or group of computer programs arranged to enable a computer or group of computers to carry out a method for controlling data access comprising the steps of creating a master set of data, associating a list of permissions with the master set of data, the permissions defining a list of containers permitted to hold a copy of the master set of data, and creating the copy by copying the master set of data to each container in the list.

According to a seventh aspect of the invention there is provided a computer program or group of computer programs arranged to enable a computer or group of computers to provide apparatus for controlling data access comprising a data record holding a master set of data, a list of permissions associated with the master set of data, the permissions adapted for defining a list of containers permitted to hold a copy of the master set of data, and a data transfer module for copying the master set of data to each container in the list.

### BRIEF DESCRIPTION OF THE DRAWINGS

Embodiments of the invention will now be described, by way of example only, with reference to the accompanying drawings in which:

FIG. 1 is a schematic illustration of a distributed database system;

FIG. 2 is a set of tables illustrating data access and distribution control lists in the database system of FIG. 1; and

FIG. 3 is a flow chart illustrating the processing carried out by one of the databases in the system of FIG. 1 when providing a user with access to stored data.

### DETAILED DESCRIPTION OF PREFERRED EMBODIMENTS OF THE INVENTION

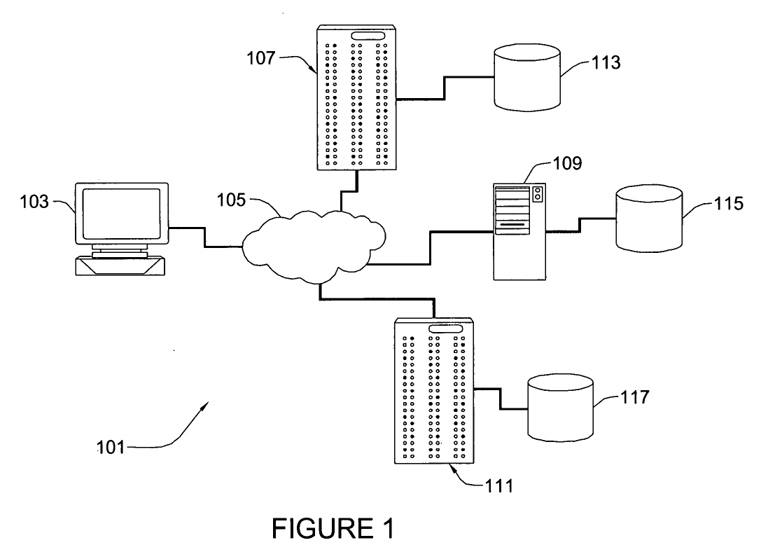

FIG. 1 shows a distributed database system 101 comprising a client computer 103 connected via a network 105 to first, second and third database servers 107, 109, 111, respectively. Each database server 107, 109, 111 is connected to respective first, second and third storage devices 113, 115, 117. The client computer can be a personal computer (PC) running a version of the Linux™ operating system and an internet browser application program. Each server 107, 109, 111 can be running a version of the Unix™ operating system along with a database and web server application programs and thereby provide first, second and third databases (not shown) respectively.

Each user of client computer 103 uses the internet browser to communicate via network 105 with first, second and third databases so as to access data held on storage devices 113, 115, 117. Other client computers (not shown) can also be connected to network 105 to enable access by further users to the data held in the databases. Each client computer may have one or more users.

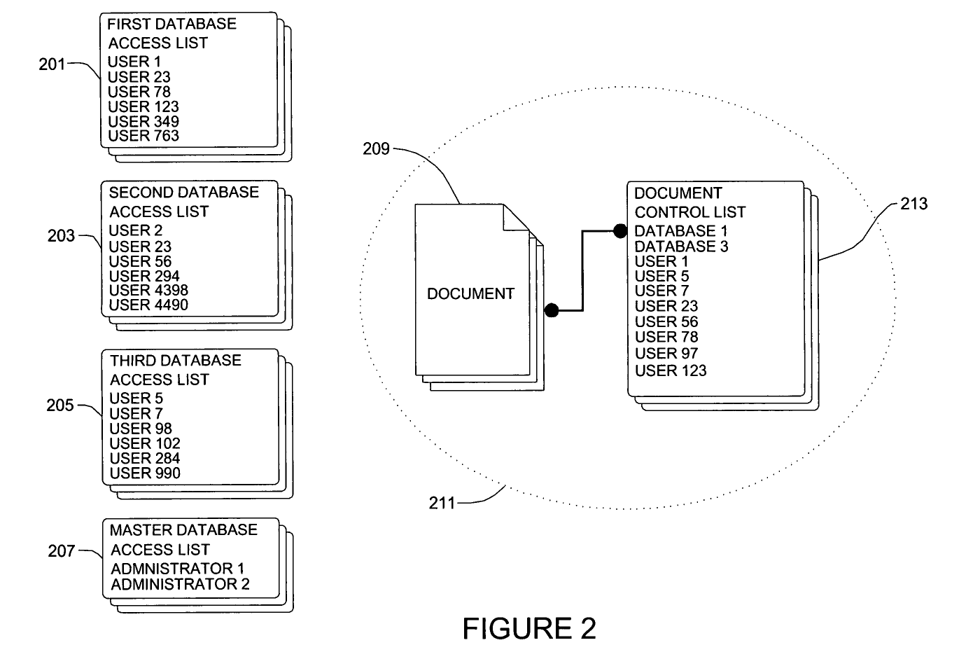

Each user of database system 101 is assigned a unique user identifier (ID) by the system manager and each of the databases 107, 109, 111 have a respective database access list 201, 203, 205 as shown in FIG. 2. Only users whose user ID appears on a given database access list can gain access to the data held by that database. Some users may have access to more than one database. As noted above, database system 101 is a distributed database and therefore much of the data can be replicated or copied across storage devices 113, 115, 117. For example, there may be a number of copies of a document in the system as a whole, each copy held on a different storage device.

Each set of data or document has a master copy to which access is strictly controlled. The master copies of all the data in system 101 is stored separately from the copied or replicated data in a master database. The master database is provided by a master database application program running on first server computer 107 and the master data is stored on first storage device 113. The master database has an access list 207 (shown in FIG. 2) which restricts access to the database administrators.

FIG. 2 illustrates an example of a master document 209 stored in a master database 211 (indicated by the shaded area) which is linked to a document control list (DCL) 213. DCL 213 defines a list of databases that are permitted to hold a copy of master document 211 and a list of users who are allowed access to the copy. When copies of master document 211 are made and transferred to the databases listed in DCL 213, a copy of the DCL is also made and transferred. The transferring is carried out by a data transfer module (not shown) of master database 211. The copy of DCL 213 is then used by each database holding a copy of the document to enforce the user permissions (not shown) defined therein. The user permissions define whether a user can have read only access, write access and whether data or a document is even visible in the database to the user. DCL 213 also holds a record of the location of master document 209 so that the origin of any copy in a database can be traced to the master document.

Depending on the contents of the access lists for the databases and on the contents of DCL 213 for a document, a number of user access scenarios are possible. For example a user may be permitted to access a document according to its corresponding DCL but not be listed in the access list of any database holding a copy of the document. Conversely, a user may be listed on all the database access lists in a system but not be listed in the DCL for a given document. Also, a document may be copied to a number of databases, a user only having access to one such database.

From the example in FIG. 2 it can be seen that users with user IDs 1, 5, 7, 78 and 123 can access document 211 via first and third databases, 201 and 205, respectively, while the user with user ID 23 can access the document via first database 201 but not third database 205. The user with user ID 56 has no access to document 209 even though that ID appears both in DCL 213 and second database access list 203 because the DCL does not allow the document to be distributed to the second database.

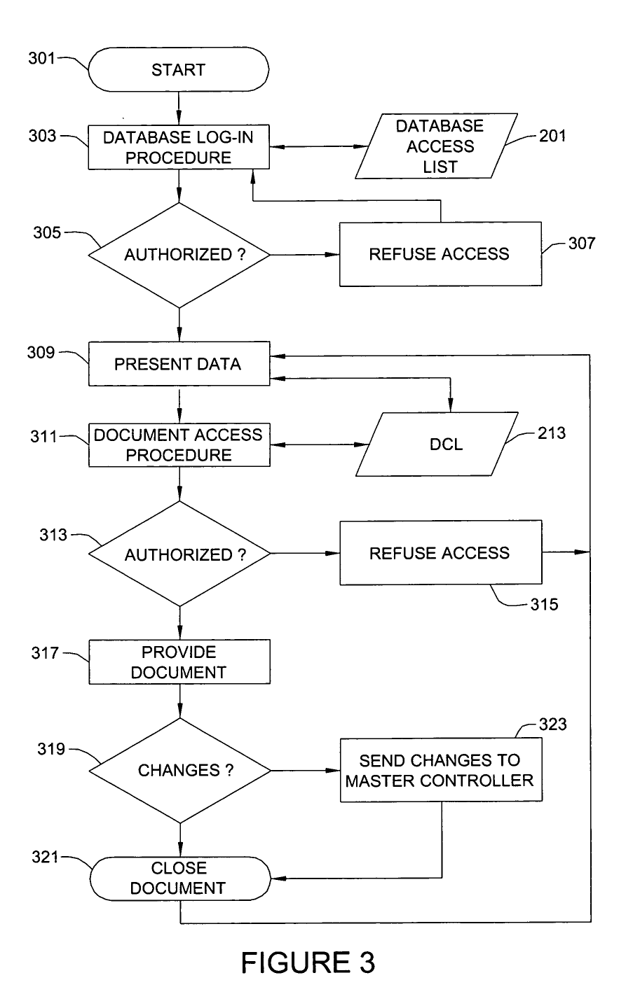

An example of the processing of first database access list 201 and DCL 213 by one of the database application programs will now be described with reference to FIG. 3. When, at step 301, a user attempts to access data in a database over network 105 then the database application program initiates the log-in procedure at step 303. In this process the user is prompted to input their user ID and an associated password. The user ID is checked against first database access list 201 to determine if the user is authorized to access that database. If the user is listed as authorized then the password is checked against the corresponding record and processing moves to step 305. At step 305, if either the user ID is not authorized or the password was incorrect then processing moves to step 307 where access to the database is denied. Processing then returns to step 303 and can proceed as described above.

If at step 305 the user is authorized and entered the correct password then processing moves to step 309 where the user ID is checked against user permissions in DCL 213 for each set of data held in the database. Only data for which the user is authorized to know the existence of in the database is presented to the user via a query engine. The query engine enables the user to search or browse the available data in the database and to make a selection for further viewing or editing. Once a selection is made then processing moves to step 311 where the user ID is again checked against DCL 213 for the selected document. Then, at step 313, if the user ID is not authorized to view the document then processing moves to step 315 where further access to the document is refused and an appropriate message displayed to the user. If at step 313 the associated permissions allow reading of the document then processing moves to step 317 where the document is provided to the user.

When the user instructs the document to be closed then processing moves to step 319, where if the document is editable by the user, it is checked for any changes. If the document is read-only or no changes have been made the processing moves to step 321 where the document is closed and processing returns to step 309. If changes have been made, processing moves to step 323 where the changes are communicated to the controller of the master document to enable the acceptance or rejection of the changes. Processing then moves to step 321 as described above and the document is closed without modification in the database.

In another embodiment, the access lists may have more detailed permissions as is common in existing database systems. In a further embodiment, DCL 213 may not be copied to the database along with the data or document but instead the master DCL is consulted over the network when a user attempts to access the associated copy of the data. In yet another embodiment, DCL 213 does not define a list of users that have access to a document but relies on the database access lists for this element of functionality. Instead, the access control from the perspective of the data relies on the lists of permitted databases. The way in which any changes to a document or other data is communicated and handled by the master data controller may be varied according to the requirements and policies for a given implementation.

As will be understood, the choice of client and server architecture chosen in the above embodiments is by way of example only and in other embodiments the architecture may vary depending on the requirements of the implementation. Furthermore, the arrangement of databases across hardware may be varied with one or more databases provided by the same hardware or all databases including the master database being provided by separate hardware. In some embodiments, one or more of the databases including the master database may be distributed over different hardware elements. There may be more than one master database in a system.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via various transmissions or storage means such as computer network, floppy disc, CD-ROM or magnetic tape so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A method for controlling data access, in a distributed database, comprising the steps of:
creating a master set of data;
associating a list of permissions with said master set of data, said permissions defining a list of containers permitted to hold a copy of said master set of data; and
creating said copy by copying said master set of data to each container in said list.

2. The method according to claim 1 further including the steps of defining a master container in said list of containers and holding said master set of data in said master container.

3. The method according to claim 1 further including the step of utilizing access controls in at least one container in said list of containers to control access to said copy of said data.

4. The method according to claim 1 wherein said creating a master set of data includes defining said set of data as a document.

5. The method according to claim 1 wherein said list of permissions further defines a list of users permitted to access a copy of said master set of data.

6. The method according to claim 5 further including the step of copying said list of permissions with each set of data to each container in said list.

7. The method according to claim 6 in which said step of copying said list of permissions includes data indicating the location of said master set of data.

8. An apparatus for controlling data access in a distributed database comprising:
a data record holding a master set of data;
a list of permissions associated with said master set of data, said permissions defining a list of containers permitted to hold a copy of said master set of data; and
a data transfer module for copying said master set of data to each container in said list.

9. The apparatus according to claim 8 in which said master set of data resides in a master container.

10. The apparatus according to claim 8 in which access controls are utilized in at least one container in said list to control access to said copy of said data.

11. The apparatus according to claim 8 in which said set of data comprises a document.

12. The apparatus according to claim 8 in which said list of permissions further comprises a list of users permitted to access a copy of said master set of data.

13. The apparatus according to claim 12 in which said list of permissions is adapted to be copied with each set of data to each container in said list.

14. The apparatus according to claim 13 in which said copy of said list of permissions in each container includes data indicating the location of the master set of data.

15. A method of accessing data in a distributed database comprising the steps of:
identifying a user and providing said user access to a database in accordance with access permissions of said database;
receiving a user selection of a document in said database;
retrieving a set of permissions associated with said selected document; and
if said user is identified in said set of permissions for said selected document then providing said user access to said document.

16. A method of controlling access to data over a plurality of distributed databases, the method comprising the steps of:
creating a document control list for a master document, said list identifying at least one database permitted to hold copies of said master document;
transmitting one or more copies of said master document to at least one of said databases identified in said document control list; and
transmitting copies of said document control list to said databases identified in said document control list.

17. The method according to claim 16 in which said creating step further includes the step of identifying the location of the master document with said document control list.

18. The method according to claim 17 further including the step of identifying one or more users who are permitted to access one or more of said copies of said document in said databases with said document control list.

19. A computer program or group of computer programs arranged to enable a computer or group of computers to carry out the method of claim 1.

20. A computer program or group of computer programs arranged to enable a computer or group of computers to provide the apparatus of claim 8.
